(19) United States
(12) Patent Application Publication
(10) Pub. No.: US 2009/0158204 A1
(43) Pub. Date: Jun. 18, 2009

(54) METHOD FOR QUICKLY VIEWING AND COMPARING SEARCH RESULTS AS SMALL AND ENLARGED IMAGES

(76) Inventor: Miguel Rocha, Houston, TX (US)

Correspondence Address: BUSKOP LAW GROUP, P.C., 4511 Dacoma Street, HOUSTON, TX, 77092, US

(21) Appl. No.: 12/332,950

(22) Filed: Dec. 11, 2008

Related U.S. Application Data
(60) Provisional application No. 61/007,274, filed on Dec. 13, 2007.
(60) Provisional application No. 61/022,180, filed on Jan. 18, 2008.
(60) Provisional application No. 61/022,508, filed on Jan. 21, 2008.
(60) Provisional application No. 61/027,740, filed on Feb. 11, 2008.
(60) Provisional application No. 61/031,373, filed on Feb. 26, 2008.
(60) Provisional application No. 61/049,123, filed on Apr. 30, 2008.

(51) Int. Cl. G06F 7/06; G06F 17/30; G06F 3/048

(52) U.S. Cl. 715/784; 707/3; 707/E17.108

(57) ABSTRACT

A method for providing search results to a client device using a search engine that presents a sequence of small images representing 100 percent of a first page of digital content simultaneously with a sequence of at least a portion of an identical page of digital content for quick viewing by a user, enabling a user to compare located information easily.

### CROSS REFERENCE TO RELATED APPLICATIONS

The present application claims priority to co-pending U.S. Provisional Patent Application Ser. No. 61/007,274 filed on Dec. 13, 2007; entitled “System for Easy Management of a Website Catalog”; U.S. Provisional Patent Application Ser. No. 61/022,180 filed on Jan. 18, 2008; entitled “Internet Search Engine with Results as Scrolling Webpage Images”; U.S. Provisional Patent Application Ser. No. 61/022,508 filed on Jan. 21, 2008; entitled “Method for Displaying Web Pages by Scrolling Their Visual Content”; U.S. Provisional Patent Application Ser. No. 61/027,740 filed on Feb. 11, 2008; entitled “Method for Scrolling Webpages with Advertising Ads”; U.S. Provisional Patent Application Ser. No. 61/031,373 filed on Feb. 26, 2008; entitled “System for Displaying and Scrolling Webpages, TV Programs, Video and Images. Including Advertising Ads”; and U.S. Provisional Patent Application No. 61/049,123 filed on Apr. 30, 2008; entitled “Method for Combining and Displaying Visual Search Engine Webpages Results, Sponsored Ads, and Video Uploaded by the Visitors”. These references are incorporated herein.

### FIELD

The present embodiments relate to a method for providing search results to a client device using a search engine that presents a sequence of small images representing 100 percent of a first page of digital content simultaneously with a sequence of at least a portion of an identical page of digital content for quick viewing by a user, enabling a user to compare located information easily.

### BACKGROUND

A need exists for a superfast way of searching the Internet that can be performed by people who may not be able to read text, or a language of a website.

The present embodiments meet these needs.

### BRIEF DESCRIPTION OF THE DRAWINGS

The detailed description will be better understood in conjunction with the accompanying drawings as follows:

FIG. 1 is a schematic of the network with servers usable with the invention.

FIG. 2 shows search results obtainable with the method of the invention.

The present embodiments are detailed below with reference to the listed Figures.

### DETAILED DESCRIPTION OF THE EMBODIMENTS

Before explaining the present apparatus in detail, it is to be understood that the apparatus is not limited to the particular embodiments and that it can be practiced or carried out in various ways.

The present embodiments relate to a method for searching for and comparing digital content on a network, such as a global communications network.

The present embodiments further relate to a method for providing search results to a client device using a search engine that presents a sequence of small images representing 100 percent of a first page of digital content simultaneously with a sequence of at least a portion of an identical page of digital content for quick viewing by a user, enabling a user to compare located information easily.

The method enables a user with a client device with a display and a client device processor with a input, computer instructions in data storage associated with the processor of the client device and a client device pointer to make a query.

A user can use a client device pointer to make a query to a search engine of a webpage. The webpage is formed from computer instructions in data storage of a webpage processor that is in communication with a global communications network such as the Internet.

The search engine operates on the global communications network, obtaining search results from at least one networked server.

The search results can be presented to the user as a sequence of small images on the display of the client device. The small images can show 100 percent of a webpage which can be obtained as part of the search results. Simultaneously with the presentation of the small images can be an identical presentation on the display of the client device of a portion of each of a set of enlarged images. The set of enlarged images can be presented in the same identical sequence as the small images. However, in the initial search results, only a portion, between about 20 percent to about 50 percent of the image is typically shown of the identical enlarged image.

A pointer that is made up of a phantom box with icon can be positioned to roll over each of the small images when actuated by the client device pointer. The pointer allows for rapid viewing of one or more of the small images to enable a view to see large numbers of search results very quickly As the pointer rolls over the small images the portions of the enlarged images also scroll past at the same rate as the pointer moves. This enables a view that can not read the language to see the small images very quickly, at a rate of about 10 per 2 seconds simultaneously with viewing at least a portion of the enlarged image that is identical to the small image.

The users, which can further be known as a viewer, uses the mouse or stylus, that is, the client device pointer to select one of the identical enlarged images from the sequence of identical enlarged images and hyperlink into digital media in data storage associated with the selected enlarged image supported by the owner of the webpage of the enlarged image.

A hyperlinked advertising area supporting at least one advertisement is provided adjacent at least one of the enlarged images.

The user can then use the client device pointer to select at least one of the advertisements, and hyperlink into digital content in data storage associated with the advertisement supported by an advertising processor.

A benefit of the invention is that the invention provides simple web page searching.

A benefit of the invention is that search results are presented in a format other than text, which enables users that are not literate in a certain text, to still view results, and capably search on the Internet.

The invention is for use with handicapped people who are perhaps dyslexic and have difficulty reading text, but still want to be able to access the references and content available on the internet.

The invention allows a user to watch television channels more easily, because with a sling box, or a combinations of sling boxes, a user can access one or more live broadcasting television channels, via the internet, from a remote location, and the user can then select between these channels remotely and view programming of up to about 1000 miles away from the user's actual television sets.

The invention allows a user that owns six sling boxes with six televisions, to view all six sling box channels as “square rooms” and select between the channels, avoiding advertising on one channel by selecting another, which enhancing the viewing pleasure of the user.

Similarly, a user can view several educational courses displayed live from a university, such as the University of Phoenix on-line and they can further move from channel to channel, completing two courses in the same time as one course. The invention is beneficial to multitasking students.

The invention can be used by digital movie content producers, allowing the producer or perhaps the director to view different segments, and select the different segments for editing purposes to produce a live, edited program immediately which can be very useful for “reality” television shows that have gotten really boring with traditional editing and cutting using standard 3-5 camera shots. This also enables the director to product the show from miles away from where the show is being shot and allow significant post production effect to be inserted on line during the process. It allows for much “richer” more textural programming.

The invention can enable sponsors or advertisers to insert ads between the “square rooms” so that the viewer sees the ads, not clouding up the results in the “square rooms” but adjacent, so that the viewed results are unimpaired, making the search engine highly desirable for advertisers. One or more ads can be placed between the “square rooms”.

The method can further allow a user to display webpages with advertising ads by horizontal or vertical scrolling with an automatic sliding.

“Scrolling” as the term is used herein refers to horizontal or vertical scrolling.

“The term “small image” as used herein can refer to the “mini-images” or “thumbnails” which are generated as a result of using the search tool described herein.

“Small images” can further refer to small image that display on a webpage, a video clip, a radio program, another audio program, a television program with advertising ads, or a television channel. Square rooms can be a “face book” clip, a U-Tube clip, an image related to a webcast, an image related to a video conference, or a similar type of digital content, live or recorded.

When a small image is selected by a user the associated “enlarged image” is presented adjacent to the small image. The enlarged image presents an entire web page although when the initial search results are presented, only a portion of the enlarged image is shown, such as about 30 percent to about 50 percent, and it is possible that up to 100 percent can be shown if the web page is small. In an embodiment, as little as 10 percent of the enlarged image can be shown.

An “enlarged image” is defined herein to be an easily viewable piece of digital media, which can be 12 point type if text is presented, or a photograph that is large enough to make out the details of what is in the photograph itself. In contrast, the small image can show the entire page of the website, such as in a 1.5 inch×1 inch size. The size of the small images can change depending on the size of the monitor. For very large monitors, such as one that is 6 feet by 8 feet, the small images can be about 5 inches high by about 6 inches long, and the portion of the enlarged imaged presented on that same monitor simultaneously with the small image might be about 5 feet by about 3 feet in size. It is contemplated that the portion of the enlarged image shown can be in size, around 10 times the size of the small image. For a monitor that is 30 centimeters wide, the small image can be about 2 centimeters by about 3 centimeters, and the portion of the enlarged image can be shown as about 20 centimeters by about 15 centimeters.

A “pointer” is a barely visible moveable frame with a highly visible icon created using computer instructions associated with the second processor allowing a user with a client device pointer to cause the moveable frame to slide over different individual small images” for fast viewing of search results.

“Automatic sliding” as the term is used herein can enable a user to quickly move between adjacent “small images” in a horizontal manner, enabling the user to look at each “square room” as quickly or as slowly as the user desires.

The term “log in” refers to the events after a user of the invention selects, with the pointer, one of the “small images” which then is converted to an “enlarged image” and then logs into to the desired web page, a TV program, or video or other digital content of the enlarged image.

Another embodiment can further provide the option for a user to perform another search without leaving the website. In an additional embodiment, the invention can allow the user to switch to other video/TV options without leaving the website.

The term user pointer can refer to a mouse, a pointer that is operated by a touch screen or a touch pad or a stylus.

For the purposes of this patent, the term “rapid” can refer to the use of the pointer very quickly over the small images, such as between about 1 seconds to about 2 seconds for at least 10 small images.

For the purposes of this patent, the term “digital content” refers to video content, static web pages, animated web pages, motion graphics, social networking sites, music, text, photographs, and similar digital materials, usually available through the Internet.

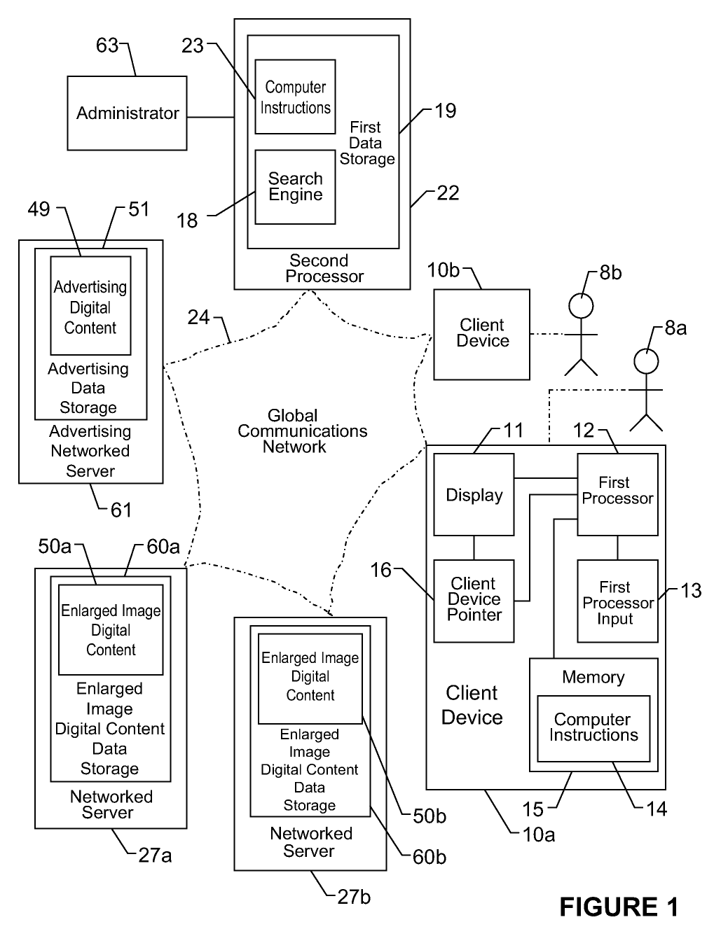

Turning now to the Figures, FIG. 1 shows a first user (8a) and a second user (8b) in communication with the global communications network (24). Each user has a client device (10a and 10b) respectively.

Each client device (10a and 10b) has a display (11) with a first processor (12), a first processor input (13) and computer instructions (14) in memory (15) that communicates with the first processor, and the computer instructions enable a client device pointer (16) to make a query to a second processor (22) in communication with the Internet (24). A search engine (18) in first data storage (19) associated with the second processor (22) in communication with the global communications network (24) and computer instructions that can filter (23) which servers are searched. The computer instructions that can filter (23) can filter either by (i) a designated country domain name extension, (ii) a global communication network without filters, (iii) digital content presented in a specified language, (iv) a designated non-country specific domain name extension, or (v) combinations thereof.

FIG. 1 also shows two networked servers (27a and 27b) that are in communication with the global communications network (24). Each networked server is depicted having enlarged image digital content (50a or 50b) in enlarged digital content data storage (60a and 60b).

Also in communication with the global communications network (24) is at least one advertising server for (61) supporting advertising data storage (51) that contains advertising digital content (49).

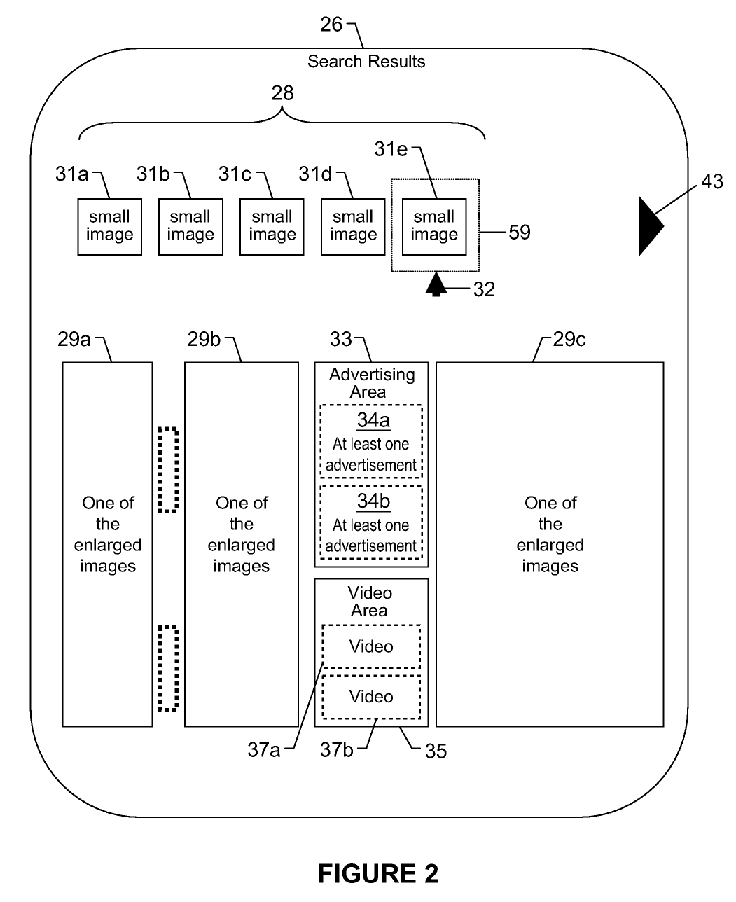

FIG. 2 depicts search results (26) presented a user as a sequence of small images (28) with individual images (31a, 31b, 31c and 31d). Each small image shows 100 percent of at least a first page of the individual search result. The small image can be a video, text, photos and text, animations, motion graphics or similar digital content.

The small images in sequence are presented simultaneously with a sequence of identical enlarged images (30).

FIG. 2 also shows a pointer (32) that has two parts, a phantom box (59) and an icon (61). The icon moves with the phantom box as a one piece object. The pointer (32) rolls over the small images when actuated by the client device pointer (such as a mouse) for rapid viewing of one or more of the associated enlarged image.

The user can select with the client device pointer one of the identical enlarged images (29a, 29b or 29c) from the sequence of identical enlarged images (30) and hyperlink into digital content (50a or 50b shown in FIG. 1) that resides in data storage (60a or 60b shown in FIG. 1) associated with the selected enlarged image. The digital content in the data storage (60a or 60b) is supported by the owner of the webpage of the selected enlarged image.

FIG. 2 also shows an advertising area (33) that in this embodiment is shown supporting two advertisement (34a and 34b). The advertising area can support one or more advertisement. The advertising area is adjacent at least one of the enlarged images. When a user uses the client device pointer to click on an advertisement (34a and 34b) the user can be hyperlinked to advertising digital content (49) depicted in FIG. 1 that is supported on an advertising server (61) in communication with the Internet. The advertising digital content can be owned and controlled by an advertiser or an administrator that controls the second processor (22), or an advertising firm.

In this way, a user can use the client device pointer to select at least one of the advertisements, and hyperlink into digital content the advertisement.

A next results icon (43) can enable a user to click on the icon to see additional small images simultaneously with at least a portion of additional enlarged images representing additional search results.

FIG. 2 also shows a video area (35) adjacent an enlarged image and/or the advertising area. The video area (35) can present at least one video and two are shown in this Figure (37a, and 37b).

An embodiment contemplates that between about five small images to about thirty small images can be shown in the sequence of small images. FIG. 2 shows ten small images per row of search results.

Another embodiment contemplates that at least two rows of small images are presented as the search results.

Still another embodiment contemplates that the portion of the identical enlarged image presented with the sequence of small images can be between about 10 percent to about 50 percent of the identical enlarged images.

The invention allows a user to scroll from top to bottom of a selected enlarged image using the client device pointer.

The invention, in an embodiment can include computer instructions that allows the user to scroll from top to bottom of the selected image at a speed corresponding to the speed at which the client device pointer is moved by the user.

The invention can also contemplate in an embodiment that the sequence of small images can be presented in a linear manner, and the user can use a mouse to move a pointer controlled by the mouse horizontally.

It is contemplated that all the small images can be viewed simultaneously as enlarged images.

While these embodiments have been described with emphasis on the embodiments, it should be understood that within the scope of the appended claims, the embodiments might be practiced other than as specifically described herein.

What is claimed is:

1. A method for search digital content on a global communication network, comprising:
a. enabling a user with a client device having a display, a first processor, a first processor input, and computer instructions in memory associated with the first processor enabling a client device pointer to query a search engine disposed in a first data storage associated with a second processor in communication with the global communications network;
b. using the search engine and the global communications network, obtaining search results comprising digital content from at least one networked server;
c. presenting the search results to the user simultaneously:
(i) a sequence of small images on the display, wherein each small image represents 100 percent of a first page of each search result; and
(ii) a sequence of enlarged images identical to the small images, wherein each enlarged image shows a portion of the small image;
d. providing a pointer for rolling over at least one of the small images in the sequence of small images using the client device pointer enabling rapid viewing of at least one enlarged images from the sequence of enlarged images;
e. enabling the user to use the client device pointer to select at least one of the enlarged images from the sequence of enlarged images and hyperlink into associated digital content in associated digital content data storage;
f. providing an advertising area supporting at least one advertisement adjacent at least one of the enlarged images; and
g. enabling the user to use the client device pointer to select at least one of the advertisements, and hyperlink to advertising digital content in advertising data storage.

2. The method of claim 1, further comprising a video area adjacent the advertising area for presenting at least one video.

3. The method of claim 1, further comprising a next results icon enabling a user to click on the icon to see additional sequences of small images on the display simultaneously with sequences of enlarged images identical to the small images.

4. The method of claim 1, wherein between 5 small images and 30 small images are shown in the sequence of small images.

5. The method of claim 4, wherein at least two rows of small images are presented as the search results.

6. The method of claim 1, wherein the enlarged image displayed is between 10 percent and 50 percent of the identical small image.

7. The method of claim 1, further comprising allowing the user to scroll from top to bottom of a selected enlarged image using the client device pointer.

8. The method of claim 1, further comprising computer instructions that allow the user to scroll from top to bottom of the selected image at a speed corresponding to a speed at which the client device pointer is moved by the user.

9. The method of claim 4, wherein the sequence of small images can be presented in a linear manner, and the user can use a mouse to move the pointer horizontally.

10. The method of claim 1, further comprising computer instructions that can filter servers searched using a member of the group consisting of:
a. a designated country domain name extension;
b. a global communication network without filters;
c. digital content presented in a specified language;
d. a designated non-country specific domain name extension; or
e. combinations thereof.
